(19) United States
(12) Patent Application Publication
(10) Pub. No.: US 2014/0180464 A1
(43) Pub. Date: Jun. 26, 2014

(54) System having a Central License Management Unit and a Tool Apparatus

(71) Applicant: Robert Bosch GmbH, Stuttgart (DE)

(72) Inventor: Ulrich Koerber, Stuttgart (DE)

(73) Assignee: Robert Bosch GmbH, Stuttgart (DE)

(21) Appl. No.: 14/137,200

(22) Filed: Dec. 20, 2013

(30) Foreign Application Priority Data
Dec. 21, 2012 (DE) 10 2012 112 835.9

(51) Int. Cl. G05B 19/18

(52) U.S. Cl. CPC G05B 19/18
USPC 700/159

(57) ABSTRACT

A system has a central license management unit and at least one tool apparatus. The at least one tool apparatus includes at least one communication apparatus and a computation unit that is provided for the purpose of switching at least one function of the tool apparatus to available mode on the basis of a piece of information received from the central license management unit by means of the communication apparatus.

This application claims priority under 35 U.S.C. §119 to patent application no. DE 10 2012 112 835.9, filed on Dec. 21, 2012 in Germany, the disclosure of which is incorporated herein by reference in its entirety.

### BACKGROUND

A tool apparatus that has at least one communication apparatus and a computation unit has already been proposed.

### SUMMARY

What is proposed is a system having a central license management unit and a tool apparatus that has at least one communication apparatus and a computation unit that is provided for the purpose of switching at least one function of the tool apparatus to available mode on the basis of a piece of information received from the central license management unit by means of the communication apparatus. In particular, a “central license management unit” is intended to be understood to mean an apparatus that is provided for the purpose of furnishing enable information packets that are required for enabling functions of a plurality of tool apparatuses. Advantageously, the central license management unit remains at one location during an instance of operation. In particular, the central license management unit can be reached via a fixed address for an electronic data transfer.

Preferably, the central license management unit furnishes the enable information packet in coded form. In particular, the computation unit is provided for the purpose of decoding the enable information packet. Preferably, the central license management unit is arranged separately from the tool apparatus. In particular, the central license management unit is connected to the tool apparatus at least via an at least partially wireless communication link. Preferably, the central license management unit furnishes the enable information packet following a payment for the function that is to be enabled. Particularly advantageously, the central license management unit sends the enable information packet to the tool apparatus, particularly after the payment for the function that is to be enabled. In particular, a “tool apparatus” is intended to be understood to mean an apparatus that, in at least one operating state, is a portion of an accessory for a tool, particularly a portion of a storage battery, of a tool and/or particularly of a motor vehicle. Preferably, the tool apparatus and the tool or the accessory are connected to one another permanently. In particular, a “tool” is intended to be understood to mean a tool that appears useful to a person skilled in the art, but advantageously a drill, a hammer drill, a percussion hammer, a saw, a plane, a screwdriver, a milling machine, a grinder, an angle grinder, a garden implement, a construction measuring instrument, an electric block and tackle, a crane and/or a multifunction tool. A “communication apparatus” is intended to be understood to mean particularly an apparatus that is provided for the purpose of transferring any information, in particular, electrically. Preferably, the communication apparatus is provided for the purpose of transferring the information wirelessly. The communication apparatus is preferably in the form of an interface that appears useful to a person skilled in the art, but particularly preferably in the form of a Bluetooth interface, in the form of a mobile radio interface and/or in the form of a WLAN interface. Alternatively, the communication apparatus could be in the form of a wired interface that appears useful to a person skilled in the art, such as a LAN interface or a USB interface. A “computation unit” is intended to be understood to mean particularly a unit having an information input, an information processing section and an information output. Advantageously, the computation unit has at least one processor, a memory, input and output means, further electrical components, an operating program, regulatory routines, control routines and/or computation routines. In particular, “provided” is intended to be understood to mean specifically programmed, designed and/or equipped. A “function of the tool apparatus” is intended to be understood to mean particularly a function that is controlled by the computation unit of the tool apparatus at least in an enabled operating state. Preferably, the function is a main function of the tool apparatus, such as a drive for an insert tool, an energy emission and/or at least one display for a measurement. Alternatively or in addition, the function could be in the form of a secondary function of the tool apparatus, such as in the form of an additional computation and/or an additional mode of operation. In this context, a “piece of information” is intended to be understood to mean particularly a state profile for a parameter received from the communication apparatus, to which state profile the computation unit assigns a meaning. In particular, the expression “switch a function to available mode on the basis of piece of information” is intended to be understood to mean that the function is available to a user at least for a period only after the information has been received and the function has been enabled by the computation unit. The disclosed refinement of the system makes it possible to achieve an advantageously remote-controlled function extension.

In a further refinement, it is proposed that the computation unit is provided for the purpose of enabling the function for a period, as a result of which it is possible to dispense with a communication link between the tool apparatus and the central license management unit for deactivating the function. In particular, the expression “enable for a period” is intended to be understood to mean that the computation unit deactivates the function of its own accord at a later time. By way of example, the function could be deactivated after a day, a week or a month.

Furthermore, it is proposed that the computation unit is provided for the purpose of transferring at least one piece of identification information to the central license management unit, as a result of which it is possible to check an authorization for the enabling of the function in a particularly convenient manner. In particular, a “piece of identification information” is intended to be understood to mean a piece of information that describes the tool apparatus, the tool and/or the accessory. Preferably, the piece of identification information has at least one serial number. Alternatively or in addition, the piece of identification information could have a piece of information that appears useful to a person skilled in the art, but preferably a piece of type information, a piece of manufacturer information, a user profile, an authentication and/or a piece of TAN information. In particular, the expression “to transfer to the central license management unit” is intended to be understood to mean that the computation unit sends the piece of identification information by means of the communication apparatus, and the central license management unit receives and particularly evaluates the piece of identification information.

In addition, it is proposed that the computation unit has a firmly programmed computation means, as a result of which it is advantageously possible to prevent manipulation and unauthorized enabling of functions. In particular, a “firmly programmed computation means” is intended to be understood to mean a computation means for which the programming in a delivered state is at least essentially unalterable. Preferably, a programming for the firmly programmed computation means is unreadable. Particularly advantageously, the firmly programmed computation means is in the form of an ASIC.

In addition, it is proposed that the system comprises an advantageously mobile computer that the computation unit uses in at least one operating state to communicate with the central license management unit, as a result of which it is possible to use a communication means of particularly simple design, particularly with a short range, in the tool apparatus. Alternatively, the tool apparatus could communicate with the central license management unit essentially directly, for example via a mobile radio network and the Internet. In particular, a “mobile computer” is intended to be understood to mean a computer that is specifically designed to be taken regularly to different work sites by a user. The mobile computer is preferably in the form of a computer that appears useful to a person skilled in the art, but advantageously in the form of a notebook, in the form of a tablet computer, in the form of a mobile telephone and/or particularly advantageously in the form of a smartphone. Alternatively, the mobile computer could be in the form of a workstation.

It is also proposed that the, in particular mobile, computer is provided for the purpose of outputting at least one piece of information about a function that can be switched to available mode, as a result of which the enableable and enabled functions can advantageously be managed by the user. The expression “output a piece of information” is intended to be understood to mean output in tactile, audible and/or advantageously visual form. Preferably, the, in particular mobile, computer has a display that displays the information to the user in at least one operating state. In particular, a “function that can be switched to available mode” is intended to be understood to mean a function that is available to the user in at least one operating state for activation and is inaccessible to the user in one operating state.

In addition, the computer is provided for the purpose of transmitting an enable period—chosen by the user—for the function to the tool apparatus, as a result of which the tool apparatus is enabled for a period that can be chosen by the user. In particular, an “enable period” is intended to be understood to mean a period in which the function, advantageously the main function, is available.

In one advantageous form of the disclosure, it is proposed that the system has a localization means that is provided for the purpose of ascertaining a position, as a result of which an unlawfully used tool apparatus can advantageously be found. In particular, a “localization means” is intended to be understood to mean a means for localization that appears useful to a person skilled in the art, but preferably a navigation satellite receiver. Preferably, the tool apparatus and/or advantageously the mobile computer of the system have the localization means. Alternatively or in addition, the localization means could at least to some extent be in a form that is integral with the communication apparatus, which in this case advantageously has a WLAN interface.

Furthermore, the disclosure is based on a tool having a tool apparatus according to the disclosure.

In addition, the disclosure is based on a storage battery, particularly a hand-held tool storage battery, having a tool apparatus according to the disclosure. A “hand-held tool storage battery” is intended to be understood to mean particularly a storage battery that is provided for the purpose of supplying electric power to a main function of a hand-held tool, particularly advantageously a hand-held tool that is in the form of a hand-held machine tool.

In this case, the system according to the disclosure is not intended to be limited to the application and embodiment that are described above. In particular, the system according to the disclosure may have a number of individual elements, components and units for fulfilling a functionality described herein that differs from a number that is cited herein.

### BRIEF DESCRIPTION OF THE DRAWINGS

Further advantages will emerge from the description of the drawings that follows. The drawing shows an exemplary embodiment of the disclosure. The drawing, the description and the claims contain numerous features in combination. A person skilled in the art will expediently also consider the features individually and combine them into useful further combinations.

In the drawings:

FIG. 1 shows a system according to the disclosure with a central license management unit, a tool, a storage battery, a mobile computer and an authentication means, and

FIG. 2 shows a schematic functional illustration for the system from FIG. 1.

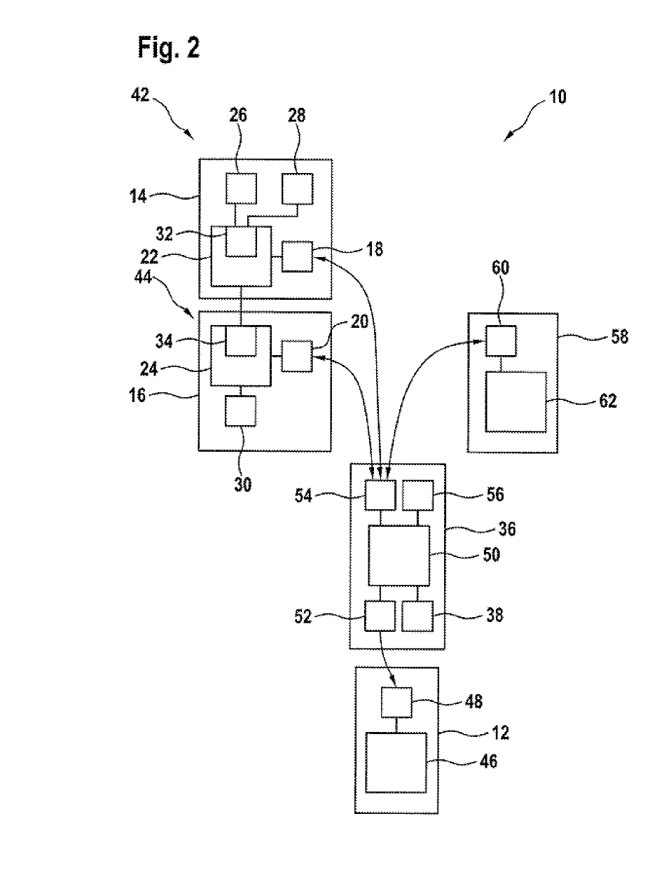

### DETAILED DESCRIPTION

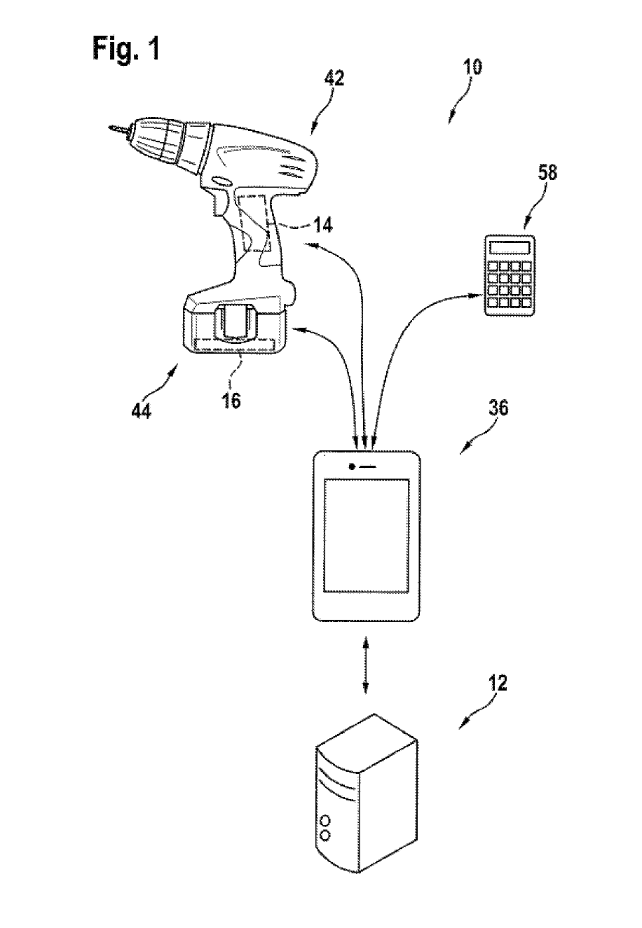

FIG. 1 shows a system 10 with a central license management unit 12, a mobile computer 36, a tool 42 and a storage battery 44. The tool 42 is in the form of a hand-held tool. The storage battery 44 is in the form of a hand-held tool storage battery. The tool 42 has a first tool apparatus 14 in the system 10. The storage battery 44 has a second tool apparatus 16 in the system 10.

The central license management unit 12 is in the form of a server. The central license management unit 12 comprises at least one computation unit 40 and a communication apparatus 48. The central license management unit 12 is connected to the Internet by means of the communication apparatus 48. The central license management unit 12 is provided for the purpose of managing enable operations for functions 26, 28, 30 for a large number of tool apparatuses 14, 16. FIG. 1 shows just two of the tool apparatuses 14, 16 managed by the central license management unit 12.

The computer 36 is in the form of a smartphone. The computer 36 is provided for the purpose of communicating at least to some extent in encrypted form with the central license management unit 12. The computer 36 has a computation unit 50, a first communication apparatus 52, a second communication apparatus 54 and a display 56. The first communication apparatus 52 is used by the computer 36 to set up a data link to the central license management unit 12 via a mobile radio network and the Internet. The second communication apparatus 54 is used by the computer 36 to set up a data link to the tool apparatuses 14, 16. The second communication apparatus 54 is in the form of a Bluetooth interface.

The tool apparatuses 14, 16 each have a communication apparatus 18, 20 and a computation unit 22, 24. The communication apparatuses 18, 20 are each in the form of Bluetooth interfaces. To enable a function of the tool 42, a communication apparatus 18 in the first tool apparatus 14 is respectively connected to the second communication apparatus 54 in the computer 36.

In this case, the tool 42 has a first and a second function 26, 28, for example. The first function 26 is in the form of a main function of the tool, namely in the form of a drive for an insert tool. The second function 28 is in the form of a supplementary function. The second function 28 allows documentation of a torque profile for a work process. Preferably, the tool 42 has further functions that can be enabled that appear useful to a person skilled in the art.

To enable a function of the tool 42, the computer 36 uses the second communication apparatus 54 to set up a data link to the communication apparatus 18 in the first tool apparatus 14. The data link is used by the computation unit 22 in the first tool apparatus 14 to send the computer 36 at least one serial number and a piece of type information for the tool 42. Furthermore, the computation unit 22 in the first tool apparatus 14 sends the computer 36 a piece of information concerning what functions in the tool apparatus 14 are currently enabled and for what kind of period they are enabled. In addition, the communication apparatus 18 in the first tool apparatus 14 sends the computer 36 further information that appears useful to a person skilled in the art, in this case a piece of make information and a use profile.

The computer 36 uses the first communication apparatus 52 to send the serial number and the piece of type information for the tool 42 to the central license management unit 12. The central license management unit 12 sends the computer 36 a piece of information that describes which of the functions 26, 28 of the tool 42 can be enabled and which of the functions 26, 28 of the tool 42 are enabled. The computer 36 indicates to the user, on the display 56, which functions 26, 28 of the first tool apparatus 14 are enabled and which functions can be enabled. Furthermore, the computer 36 indicates to the user how long the currently enabled functions 26, 28 are enabled as appropriate.

In this case, the storage battery 44 has the enableable function 30, which is in the form of a main function of the storage battery 44, namely in the form of a power supply for the tool 42. The function 30 of the storage battery 44 is enabled as described for the enabling of one of the functions of the tool 42. The storage battery 44 could have further enableable functions that appear useful to a person skilled in the art, such as an inductive charge capability and/or fast charge capability.

The computer 36 is provided for the purpose of performing a buying process for buying and enabling one of the functions 26, 28, 30. To enable one of the functions 26, 28, 30, the central license management unit 12 sends the computer 36 an enable information packet. The enable information packet comprises a piece of information concerning when which of the functions 26, 28, 30 is intended to be enabled. In addition, the enable information packet comprises a piece of information concerning what kind of serial number is possessed by the tool apparatus 14, 16 on which the function 26, 28, 30 is intended to be enabled. Furthermore, the enable information packet has a piece of information concerning the maximum length of time for which the function 26, 28, 30 can be enabled. The computer 36 is provided for the purpose of transferring a piece of identification information for the computer 36, e.g. an IP address and/or an IMEI, to the central license management unit 12 when one of the functions 26, 28, 30 is enabled.

Furthermore, the computer 36 allows the user himself to determine the length of time for which the function 26, 28, 30 is intended to be enabled. By way of example, the main function of a tool or of an accessory can be enabled by an owner for a particular period. When this period has elapsed, the relevant computation unit 22, 24 disables the main function. This can reduce an incentive to steal the tool 42 or the storage battery 44.

The computation units 22, 24 of the tool apparatus 14, 16 each have a firmly programmed computation means 32, 34. The firmly programmed computation means 32, 34 are in the form of ASICs. The computation units 22, 24 each comprise a timing means that is provided for the purpose of determining a time that the computation units 22, 24 can use to determine when an enabled period elapses.

The computer 36 enables the function by sending the enable information packet to the communication apparatus 18 in the first tool apparatus 14. The firmly programmed computation means 32 in the computation unit 22 of the first tool apparatus 14 checks the enable information packet. If the enable information packet is provided for the purpose of enabling one of the functions 26, 28 of the tool 42, the firmly programmed computation means 32 enables the function 26, 28 in accordance with the information that the enable information packet contains. Instead of the firmly programmed computation means 32, a programmable processor in the computation means 32 could check the enable information packet.

The computer 36 has a localization means 38 that is provided for the purpose of ascertaining a position. When the computer 36 sets up a connection to one of the tool apparatuses 14, 16, the computer 36 sends the position and a serial number of the tool apparatus 14, 16 to the central license management unit 12. The central license management unit 12 comprises a database containing serial numbers of stolen tool apparatuses. If the tool apparatus 14, 16 is registered as stolen, the central license management unit 12 stores the position of the computer 36. In addition, the central license management unit 12 sends the computer 36 a command to disable all functions 26, 28, 30 of the tool apparatus 14.

Furthermore, the system 10 has an authentication means 58 with a communication apparatus 60 and a computation unit 62. The authentication means 58 is in the form of a TAN generator. The communication apparatus 60 in the authentication means 58 is provided for the purpose of communicating with the computer 36 via Bluetooth. Alternatively, an authentication means in the system 10 could receive a piece of information visually from the computer 36 and advantageously output it to the user via a display. The authentication means 58 is provided for the purpose of authenticating the owner when one of the functions 26, 28, 30 is ordered and/or when one of the functions 26, 28, 30 is enabled by an owner for a particular period. The authentication means 58 uses the communication apparatus 60 to send the authentication to the computer 36. Alternatively, the user could input a TAN, produced by an authentication means, on the computer.

What is claimed is:

1. A system comprising:
a central license management unit; and
at least one tool apparatus including (i) at least one communication apparatus and (ii) a computation unit configured for switching at least one function of the at least one tool apparatus to an available mode on the basis of a piece of information received from the central license management unit via the communication apparatus.

2. The system according to claim 1, wherein the computation unit is configured to enable the at least one function for a period.

3. The system according to claim 1, wherein the computation unit is configured to transfer at least one piece of identification information to the central license management unit.

4. The system according to claim 1, wherein the computation unit includes a firmly programmed computation unit.

5. The system according to claim 1, further comprising:
a computer that the computation unit is configured to use in at least one operating state to communicate with the central license management unit.

6. The system according to claim 5, wherein the computer is configured to output at least one piece of information about a function that can be switched to available mode.

7. The system according to claim 5, wherein the computer is to transmit an enable period for the at least one function, which is chosen by a user, to the tool apparatus.

8. The system according claim 1, further comprising:
a localization mechanism configured to ascertain a position.

9. A tool apparatus in a system having a central license management unit, the tool apparatus comprising:
at least one communication apparatus; and
a computation unit configured for switching at least one function of the at least one tool apparatus to an available mode on the basis of a piece of information received from the central license management unit via the at least one communication apparatus.

10. A tool comprising:
a tool apparatus including:
at least one communication apparatus; and
a computation unit configured for switching at least one function of the at least one tool apparatus to an available mode on the basis of a piece of information received from a central license management unit via the at least one communication apparatus.

11. A storage battery having a tool apparatus according to claim 9.

12. A mobile computer in a system according to claim 5.

13. The tool according to claim 10, wherein the tool is a hand-held tool.

14. The storage battery according to claim 11, wherein the storage battery is a hand-held tool storage battery.
